(19) United States
(12) Patent Application Publication
(10) Pub. No.: US 2026/0178965 A1
(43) Pub. Date: Jun. 25, 2026

(54) Method for Autonomously Identifying Specific Information in Data Items

(71) Applicant: Varonis Systems, Inc., New York, NY (US)

(72) Inventors: Amit Osi, Tel Aviv-Yafo (IL); Amir Belgi, Ra'anana (IL); Liron Raveh, Pardes Hanna-Karkur (IL); Lior Chen, Tel Mond (IL); Amit Cohen, Kfar-Saba (IL)

(21) Appl. No.: 18/991,992

(22) Filed: Dec. 23, 2024

(51) Int. Cl. G06N 20/00; G06F 40/295

(52) U.S. Cl. CPC G06N 20/00; G06F 40/295

(57) ABSTRACT

Broadly speaking, the present techniques provide a method for training a machine learning, ML, model to perform named entity recognition in data items within an environment, and a method for using a trained ML model to autonomously perform named entity recognition. Advantageously, the present techniques enable sensitive information located in data items to be protected, which thereby reduces risk of data items that contain sensitive information from being accessed or manipulated by anyone without the requisite authority. In other words, by knowing what data items contain, appropriate security policies can be applied to the data items, and actions with respect to the data items can be controlled. The present techniques may also enable efficient and effective extraction of sensitive information from large sets of data items.

### FIELD

The present application generally relates to a method for autonomously identifying specific information in data items. In particular, the present application provides a method for training a machine learning, ML, model to perform named entity recognition in data items within an environment, and a method for using a trained ML model to autonomously perform named entity recognition.

### BACKGROUND

Many organisations have policies which control actions that can be performed using or with respect to data items within the organisations. For example, organisations may have a policy to retain all emails sent and received by a person within the organisation for five years, after which they can be deleted. Similarly, organisations may have a policy that prevents certain data items from being transmitted outside of the organisation, or which controls who can access the data items within the organisation, or which controls how long data items should be retained before they can be deleted/purged. With huge volumes of digital data items being generated within organisations on a yearly and even daily basis, it is desirable to automate the application of such policies to the data items. However, this may require understanding the data items in some way, so that the appropriate policy/policies can be applied. For example, it may be useful to classify the data items. Currently, classification rules that help to determine how data items are classified may be manually generated, which is difficult and time consuming.

Similarly, IT security officers face the critical task of providing detailed information and timely analysis following a data breach or event investigation. While identifying breached data and its ownership is essential, it is not always sufficient. Security officers must also understand the context of the data. This is because if there has been a breach, it is useful for any named in data items impacted by the breach to know exactly what data relating to them has been accessed. For example, a person may not consider it to be a problem if the breached data items are emails sent about office stationery supplies to their colleagues, but they may consider it to be more problematic if the breached data items include their personnel files.

The challenge is bigger in the unstructured data domain, especially when dealing with large-scale breaches involving millions of documents. Even if the security officer could leverage existing solutions to obtain breached documents (such as emails, presentations, or plain text files) and classify them, linking each document to a specific entity based on its contents remains a complex and time-consuming task.

The present applicant has therefore recognised the need for an improved way to efficiently and accurately label and classify data items containing specific named entities.

### SUMMARY

In a first approach of the present techniques, there is provided a computer-implemented method for training a machine learning, ML, model to perform named entity recognition in data items within an environment, the method comprising: selecting, from a plurality of unlabelled data items stored by at least one data storage device within the environment, a subset of data items; obtaining at least one pre-defined named entity for the environment; determining whether each data item of the selected data items contains the obtained at least one pre-defined named entity; generating a training dataset comprising the selected subset of data items by labelling each data item in the selected subset by: labelling the data item with a first label when the data item is determined to contain the at least one pre-defined named entity, or labelling the data item with a second label when the data item is determined to not contain the at least one pre-defined named entity; and training the machine learning, ML, model using the generated training dataset to perform named entity recognition.

Named entity recognition, NER, is a task of information extraction that seeks to locate and classify entities mentioned in unstructured text into pre-defined categories, such as person names, organisations, locations, temporal expressions, numerical expressions/quantities, monetary values, etc. NER is also known as entity extraction. More generally speaking, NER is a type of natural language processing that identifies pre-defined categories of objects in text. NER takes a string of text (e.g. a phrase, a sentence, a paragraph, or even a whole document), and identifies and classifies the entities that relate to each category.

In order to apply security policies to digital data items within an organisation, it is necessary to be able to understand the content of those data items. For example, it may be desirable to restrict access to data items that mention certain key words or which contain sensitive information. It is not always obvious from the title of the data item (e.g. a Word doc) what it contains. So, it is desirable to have a quick way to identify each data item that contains information of interest to the organisation. This could be particular key words, names, locations, personal information, business information, etc. It is laborious to manually-label all data items within an organisation.

Broadly speaking, the present techniques provide a method to automatically label data items that contain one or more named entities (e.g. keywords, names, car number plates, addresses, etc.) The method is being performed within an environment, i.e. on data items stored within that environment and with respect to named entities of interest to that environment. The environment may be, for example, a business, workplace, organisation, department within an organisation (e.g. HR, legal or accounting), etc. To do this, it is first necessary to train a machine learning model to recognise the named entities of interest within data items. Preferably, the method is performed within an environment so that the dataset is environment-specific, which thereby means the ML model is specifically trained for that environment too.

Advantageously, the present techniques enable sensitive information located in data items to be protected, which thereby reduces risk of data items that contain sensitive information from being accessed or manipulated by anyone without the requisite authority. In other words, by knowing what data items contain, appropriate security policies can be applied to the data items, and actions with respect to the data items can be controlled. The ability to identify specific named entities, such as names of individuals, social security numbers, drivers'licenses, home addresses, email addresses, and so on, from a large collection of data items can significantly enhance data security solutions. It may, in some cases, be desirable to extract, remove or redact specific named entities from data items. The present techniques may also enable efficient and effective extraction of sensitive information from large sets of data items. This could solve a major problem in the data security industry, i.e. how to quickly and efficiently identify and extract certain information from data items.

The method may be implemented by a central server, computer or platform device that is located within the environment and has access to the data items stored within that environment.

Preferably, a separate machine learning model is trained in each environment, with data items from that environment. In other words, the training results in a model that is trained on the data items of that environment, and to identify named entities that are of particular interest to parties associated with that environment. That is, model A may be trained for company A using company A's data items and named entities of interest, and model B may be trained for company B using company B's data items and named entities of interest. This ensures data security and privacy is preserved during the training process, and ensures that the model is trained to perform named entity recognition on data items within each environment (which could vary in type, format, style, content, and so on between different environments).

The or each data storage device may be any computing device within the environment. Examples of computing devices include laptops, desktop computers, smartphones, servers, and so on. More generally, the at least one data storage device may be any data storage within the environment, which includes file servers and any cloud-based data storage, such as those provided by Microsoft SharePoint, Google Drive, and so on.

The data items may be any one or more of the following types of data item: an email, a document, a file, a text file, a folder, an image, a video, an audio file, a diagram, a geographical map, a medical image, a medical data file, a chat history (e.g. a Microsoft Teams chat history or a Slack chat history), a transcript of an audio or video meeting (e.g. a Microsoft Teams meeting or Zoom meeting), a prompt entered into an AI tool, and a portable document format file. It will be understood that this is a non-exhaustive and non-limiting list of example data item types.

The at least one pre-defined named entity may be any specific entity or class/category of entity types. For example, a specific named entity may be the name of a specific individual, e.g. “John Smith”, while a class/category may be personal names. The named entity may be, for example, names of specific individuals (e.g. personnel or people associated with the environment, including client names), person names, organisation names, locations, financial information, passport number, driver license number, car registration number/license plate, social security number or national insurance number, employee ID, monetary values, and so on. It will be understood that named entities are not limited to proper nouns or names of individuals, locations or organisations. It will also be understood that the above is a non-exhaustive and non-limiting list of example named entities.

The step of obtaining at least one pre-defined named entity for the environment may comprise obtaining the pre-defined named entity from a human administrator of data storage and data security policies within the environment. This may enable the named entities to be specific to the environment. Alternatively, the named entities may be obtained, extracted or predicted by a pre-trained large language model operating on labelled or unlabelled data items from that environment.

The step of selecting data items may comprise selecting data items that are most likely to improve training of the ML model, for example, by having a distribution that is most likely to improve training of the ML model. That is, it may be advantageous to populate the training dataset with data items that will improve the training of the ML model. Typically, data items that are diverse in content, format, style, and so on improve the training of a ML model. Similarly, data items which are more difficult to classify (i.e. more difficult to determine whether they contain a named entity) may be more useful to train the ML model.

A model that has been specifically trained to perform “smart sampling” may be used to perform the step of selecting data items. The model may be trained using the method described in US patent application number U.S. Ser. No. 18/921,328, which is herein incorporated by reference in its entirety. The model may be separate to the model that is being trained to perform named entity recognition in data items. Alternatively, both the smart sampling model and the model for performing named entity recognition (NER) may be part/subsets/sub-modules of a larger model or system. The smart sampling model may select a plurality of data items which are deemed, by the model, to be most useful for the training of the model being trained to performed NER. The most useful data items may be those which are difficult to categorise. The smart sampling model may have been specifically trained to identify whether a data item contains a named entity (a specific named entity/entities (e.g. Joh Smith), or broader classes of named entities (e.g. person's name). In this way, when the smart sampling model is unsure about the presence of a named entity in a data item, that data item may be more useful for training the model being trained to perform NER.

Thus, the step of selecting data items may comprise: identifying data items, from the plurality of unlabelled data items, for which a prediction is made with a low confidence; and selecting the identified data items as being that are most likely to improve training of the ML model. The identifying and selecting may be performed by the smart sampling model.

The step of identifying data items may comprise identifying data items for which a prediction is made, by the smart sampling model, with a confidence lower than (less than) a pre-defined confidence level. In general, better training of the ML model for NER will be gained from data items in the training dataset that are harder to make predictions for or which lead to predictions having a low confidence (for example, but not limited to, between 0.3 and 0.7). That is, data items which the smart sampling model struggled to categorise into one of two sets as the prediction was close to 0.5 (on a scale of 0 to 1 between the two sets). Data items with predictions outside of this range may be excluded from consideration as it is unlikely they will have an effect on the quality of training of the model for NER. In another example, the data items may be divided into three groups: low confidence (<0.2), medium confidence (0.2 to 0.8), and high confidence (>0.8). The data items having predictions with the lowest confidence may be preferred and so data items in this group may be preferred. However, for data diversity, and so that the model is not only trained on very difficult data items, the selecting may also comprise selecting some data items from the other two groups.

Additionally or alternatively, the step of selecting data items may comprise: clustering the plurality of unlabelled data items into two or more clusters; and selecting data items from the two or more clusters. In one example, a k-clustering process may be utilised to generate clusters of data items. In the clustering approach, each data item may be converted to a numeric vector representation (embedding) using any suitable technique(s). In one example, generating the embedding vector for each data item (or segment thereof) may comprise using models such as Word2Vec, GloVe, or transformer-based models like BERT. As is known in the field, the embeddings represent the semantic meaning of the processed text. The embedding process could be performed in advance or during the selection process.

The embeddings may then be clustered to group semantically-similar data items together into clusters, for example using an algorithm such as k-means or DBSCAN. These algorithms are well known and the following brief description is considered sufficiently to enable implementation in accordance with known techniques. In K-means clustering the dataset is separated into k clusters by minimising the variance within each cluster. The variance can be quantified using a technique such as cosine similarity or Euclidean distance, both of which will be familiar to the skilled reader.

Another approach is DBSCAN (Density-Based Spatial Clustering of Applications with Noise) in which points which are closely packed are grouped, and isolated points in low-density areas are marked as noise. The DBSCAN approach does not require the number of clusters to be pre-decided whereas K-means does.

The number of clusters can be selected based on a number of factors regarding the dataset, requirements and resources. Resources (for example cost, processing capacity, and/or time) may place a limit on the number of documents that can be labelled and hence k can be selected appropriately to provide a suitable number of data items within that limitation. For example, if one data item is to be selected per cluster k would be set to the maximum number of data items that can be labelled.

Characteristics of the data may be utilised to determine the preferred number of clusters. For example, the Elbow Method or Silhouette Analysis may be used to determine the optimal number of clusters to ensure broad coverage.

The number of clusters can also be defined iteratively depending on the perform of the smart sampling model at each iteration.

Once the clusters are formed, representative data items may be selected from each cluster. This may be performed using any suitable technique. For example, selection may be based on:-
a. Selecting the data item(s) closest to the cluster centroid.
b. Selecting data items that are most diverse within the cluster (i.e. furthest apart from each other).
c. Selecting data items having embeddings that are most far apart, in embedding space, from the embeddings of previously selected data items.

In a further example, to select a set of k data items, k/2 clusters may be defined, with one data item from close to the centre of each cluster, and one additional data item (for example an outlier), selected for each cluster. K data items are therefore selected.

This approach can be generalised to define k as the number of data items, and t as the number of clusters to create. The number of data items to select from each cluster is therefore k/t. The data item scan be selected from each cluster in a way that maximizes coverage within each cluster, for example by selecting data items that are farthest away from each other, or selecting a mixture of typical and atypical data items (central or outlier). The aim of the selection is to give a fair representation of all clusters and to capture the variability across the dataset.

In a further example t clusters are formed and a set of data items is selected from each cluster by starting with a random data items and then iteratively selecting additional data items which maximise the distance (of their embeddings, in embedding space) between them and previously chosen data items.

Each of these examples is intended to select a subset of the data items with a distribution across the unlabelled data items. The expectation is that the distribution of data items achieves improved training performance compared to a random selection, while also reducing the number of data items to be labelled at each iteration. The number of data items selected can be defined based on how accurate the model being trained to perform NER needs to be, and the resources available for labelling data items and re-training the model.

Preferably, selecting data items from the two or more clusters may comprise selecting data items that are far apart from each other within each cluster.

The method may further comprise: determining, using a large language model, LLM, whether each data item of the selected data items contains the at least one pre-defined named entity; wherein generating the training dataset by labelling each data item comprises using the determining to label each data item with the first label or second label. That is, the step of labelling the selected, unlabelled data items may comprise using an LLM to analyse the content of the data items and determining whether the named entity (or entities) are present within the data items. This advantageously harnesses the power of LLMs, but on a small set of data items, which is more efficient than analysing all the data items within the environment with an LLM. In other words, using an LLM is useful because an LLM is powerful and that power is used to form the training dataset. However, an LLM is too inefficient to use to analyse all the data items in an organisation. So, instead, it is used to generate the training dataset, and then another smaller, more efficient model (e.g. a classifier) is trained using that training dataset to identify data items with a high chance of containing the named entities.

The step of determining whether each data item contains the at least one pre-defined named entity may comprise: identifying text, using the LLM, in each data item which corresponds to the at least one pre-defined named entity.

Prior to the identifying, the method may comprise: converting a non-text data item into text. This may be useful for data items that do not contain any text content which can be easily processed or analysed by the LLM. The converting may comprise generating text content for a non-text data item. The generated text content may be a description or summary of the non-text data item. For example, if the non-text data item is an image (e.g. photograph, frame of a video, medical image, graph, schematic diagram, flowchart, diagram, etc.), the generated text content may summarise the meaning and content of the image. In another example, if the non-text data item is an image that contains text (e.g. a photo of a passport or driver's license), then the text within that image may be extracted from the image to generate the text content. A large language model may be used to generate the text content, for example. This may be the same LLM which is used to label the data items.

Prior to training the ML model, the method may comprise determining whether the training dataset comprises at least a first pre-determined number of data items with the first label and at least a second pre-determined number of data items with the second label. When the training dataset contains less than the first pre-determined number of data items with the first label and the second pre-determined number of data items with the second label, the method may comprise repeating the steps to select a subset of data items, determine whether the data items contain at least one pre-defined named entity, and generate a training dataset. The first pre-determined number may be the same as or different to the second pre-determined number. For example, it may be useful to have an equal number of positive samples (those which contain a named entity) and negative samples (those which do not contain a named entity), or it may be useful to have more of one type of sample than another.

Prior to determining whether each data item of the selected data items contains the at least one pre-defined named entity, the method may further comprise: dividing the selected data item into two or more segments having a size suitable for processing by the ML model that is being trained, wherein the determining is performed for each segment of the two or more segments. That is, in cases where a data item is very large or contains a lot of text, the LLM may find it difficult to process the data item in one go. Thus, it is useful to divide the text content within the data item (or the text content generated for or extracted from a non-text data item) into chunks or segments. One reason for this is that the context window of many models is limited. For example, for OpenAI, the context window is 8k tokens (i.e. words), and for some open-source models, it can be as low as 512 tokens (words). So, it is necessary to reduce the amount of text that is fed into the model to identify whether any named entities are present. The text may be divided into pages, paragraphs, or into segments of a certain number of words. It will be understood that any suitable way of dividing the text may be used. Dividing the extracted text content into segments is also known as “chunking”.

Prior to the determining, the method may further comprise: translating text in the selected data item into a pre-defined natural language. A natural language is any language used by humans, as opposed to, for example, computer programming languages. The pre-defined natural language may be a human language that is selected or determined in advance, and may be linked to the language used to train the machine learning model and/or the language best understood by the LLM. Any suitable technique may be used to perform the translation. For example, the translation may be performed using machine translation techniques, which may utilise a large language model or other natural language processing mechanism.

Training the machine learning, ML, model using the generated training dataset to identify sensitive information may comprise training a classifier or classification model. Classifiers are a type of machine learning model that divide data into groups called classes. Classifiers learn class characteristics from training data and learn to assign possible classes to new data items using those learned characteristics.

Training the machine learning, ML, model using the generated training dataset may comprise, for each data item in the training dataset: determining, using the ML model, a label for the data item indicating whether the data item contains at least one pre-defined named entity; calculating a loss based on a difference between the determined label with the label of the data item that is applied during generation of the training dataset; and training the ML model to minimise the calculated loss. Any suitable training technique may be used.

In a second approach of the present techniques, there is provided a computer-implemented method for using a trained machine learning, ML, model to autonomously perform named entity recognition in data items within an environment, the method comprising: determining, using the trained ML model, for each unlabelled data item stored by at least one data storage device within the environment, whether the unlabelled data item contains at least one pre-defined named entity; assigning each unlabelled data item with a likelihood score indicating how confident the trained ML model is that the unlabelled data item contains the at least one pre-defined named entity; comparing each assigned likelihood score to a pre-defined threshold likelihood score; and identifying, when the comparing determines that an assigned likelihood score is greater than or equal to a pre-defined threshold likelihood score, a location of the at least one pre-defined named entity within the unlabelled data item.

Thus, as mentioned above, the present techniques provide a method of using the trained model (e.g. classifier) to autonomously and automatically identify the pre-defined named entities in all data items stored within the environment. This involves analysing the data items with the trained model. The trained model assigns each data item with a score indicating the likelihood that the data item contains at least one pre-defined named entity. For example, this score may indicate an 80% likelihood that a data item contains a driver's license number. Each data item with a score over a certain threshold value is processed further. This means that only those data items with a high score are processed in detail, which is more efficient than carefully processing all data items.

The identifying may comprise using a large language model, LLM, to identify the location of the at least one pre-defined named entity within the unlabelled data item. This may be the same LLM which was used to generate the training dataset.

The method may further comprise: labelling each unlabelled data item having an assigned likelihood score greater than or equal to the pre-defined threshold likelihood score with at least one label corresponding to the at least one pre-defined named entity contained within the unlabelled data item. That is, an unlabelled data item may be labelled if the assigned score is above the threshold, so that the data item is now clearly marked as containing a specific named entity. The label may be specific to the named entity. For example, if a person's name is identified in the data item, the label applied to the data item may be “Name”. Similarly, if a specific town or city is identified in the data item, the label applied to the data item may be “Location”. Any suitable labelling technique may be used, depending on what is required for that particular environment or the security policies being deployed within that environment.

For each unlabelled data item having an assigned likelihood score greater than or equal to the pre-defined threshold likelihood score, the method may further comprise: outputting a snippet or summary of text in the unlabelled data item in which the at least one pre-defined named entity appears. This may be useful because it allows others, e.g. an administrator, to quickly see the context in which the named entity appears in the data item.

For each unlabelled data item having an assigned likelihood score greater than or equal to the pre-defined threshold likelihood score, the method may further comprise: extracting, redacting or deleting the at least one pre-defined named entity identified within the unlabelled data item.

In a third approach of the present techniques, there is provided a system for using a trained machine learning, ML, model to autonomously perform named entity recognition in data items within an environment, the system comprising: a plurality of data storage devices, each data storage device storing a plurality of labelled and unlabelled data items; at least one processor coupled to memory, arranged for: determining, using the trained ML model, for each unlabelled data item stored by the plurality of data storage device within the environment, whether the unlabelled data item contains at least one pre-defined named entity; assigning each unlabelled data item with a likelihood score indicating how confident the trained ML model is that the unlabelled data item contains the at least one pre-defined named entity; comparing each assigned likelihood score to a pre-defined threshold likelihood score; and identifying, when the comparing determines an assigned likelihood score is greater than or equal to a pre-defined threshold likelihood score, a location of the at least one pre-defined named entity within the unlabelled data item.

The identifying may be performed by a large language model, LLM. In some cases, the identifying may comprise sending the unlabelled data item to an LLM that is located outside of the environment. This may be used if the data security policies permit data items to be transmitted with an LLM outside of the environment. In alternative cases, the LLM may be located inside the environment, to preserve data security and privacy.

The system may further comprise a large language model, LLM. In this case, the identifying may comprise using the LLM, to identify the location of the at least one pre-defined named entity within the unlabelled data item.

The features described above with respect to the second approach apply equally to the third approach and therefore, for the sake of conciseness, are not repeated.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

### BRIEF DESCRIPTION OF THE DRAWINGS

Implementations of the present techniques will now be described, by way of example only, with reference to the accompanying drawings, in which:

FIG. 1 shows a flowchart of example steps for training a machine learning, ML, model to perform named entity recognition in data items within an environment;

FIG. 2 is a flowchart of example steps for using a trained machine learning, ML, model to autonomously perform named entity recognition in data items within an environment; and

FIG. 3 is a block diagram of a system for using a trained machine learning, ML, model to autonomously perform named entity recognition in data items within an environment.

### DETAILED DESCRIPTION OF THE DRAWINGS

Broadly speaking, the present techniques provide a method for training a machine learning, ML, model to perform named entity recognition in data items within an environment, and a method for using a trained ML model to autonomously perform named entity recognition. Advantageously, the present techniques enable sensitive information located in data items to be protected, which thereby reduces risk of data items that contain sensitive information from being accessed or manipulated by anyone without the requisite authority. In other words, by knowing what data items contain, appropriate security policies can be applied to the data items, and actions with respect to the data items can be controlled. The present techniques may also enable efficient and effective extraction of sensitive information from large sets of data items.

As noted above, it is a challenge to efficiently and accurately extract specific Named Entity Recognition (NER) entities such as Social Security Numbers (SSNs) or drivers'license numbers from a large collection of unlabelled data. This is challenging due to the sheer volume of the data, the potential for computational and monetary costs associated with running Language Models (LLM) on all of the data, and the necessity for high accuracy in identifying and extracting these sensitive details.

The present techniques provide a solution to this problem, via a multi-step process of data labelling, model training, prediction, and filtering. Initially, small portions of data are used to extract NER entities using an LLM. The labelled data is then used to train a classifier model via automated machine learning (AutoML). This classifier model serves as a filter, predicting the likelihood of finding the specific NER entity in a document. Documents with high prediction scores are then processed further by the LLM to pinpoint where in the document the entity exists. This approach allows for efficient processing of large data sets, minimizes the cost by reducing the need to run LLM on all documents, and ensures high accuracy in extracting specific sensitive data.

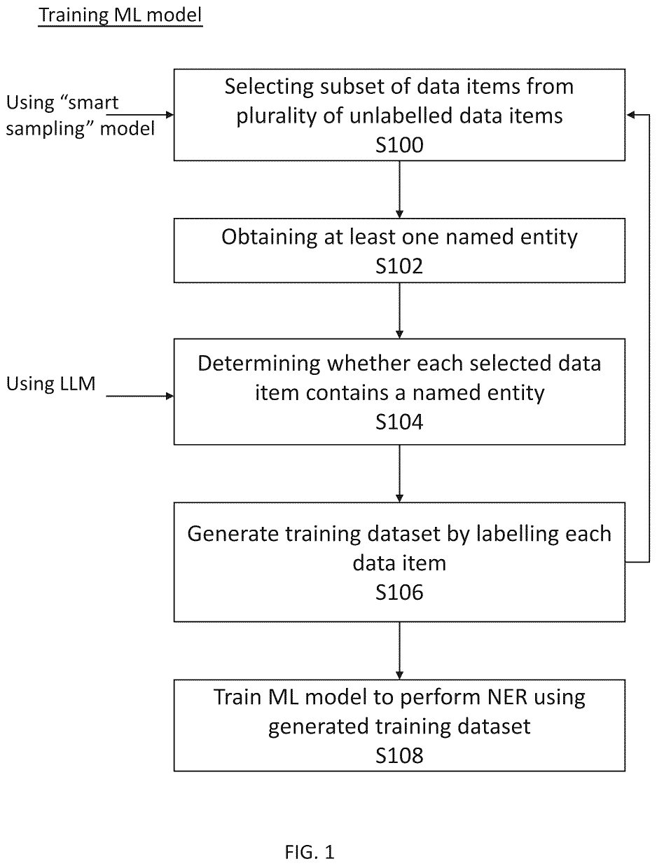

FIG. 1 shows a flowchart of example steps for training a machine learning, ML, model to perform named entity recognition in data items within an environment. The method comprises: selecting, from a plurality of unlabelled data items stored by at least one data storage device within the environment, a subset of data items (step S100); obtaining at least one pre-defined named entity for the environment (step S102); determining whether each data item of the selected data items contains the obtained at least one pre-defined named entity (step S104); generating a training dataset comprising the selected subset of data items by labelling each data item in the selected subset by: labelling the data item with a first label when the data item is determined to contain the at least one pre-defined named entity or labelling the data item with a second label when the data item is determined not to contain the at least one pre-defined named entity (step S104); and training the machine learning, ML, model using the generated training dataset to perform named entity recognition (step S106).

Thus, the process begins with data labelling, where small portions of data are taken from the large, unlabelled dataset and labelled to form a training dataset. This step of selecting data items from the unlabelled data items (S100) may be performed until enough positive and negative examples have been collected.

At step S100, the data items being selected may each be any one or more of the following types of data item: an email, a document, a file, a text file, a folder, an image, a video, an audio file, a diagram, a geographical map, a medical image, a medical data file, a chat history (e.g. a Microsoft Teams chat history or a Slack chat history), a transcript of an audio or video meeting (e.g. a Microsoft Teams meeting or Zoom meeting), a prompt entered into an AI tool, and a portable document format file. It will be understood that this is a non-exhaustive and non-limiting list of example data item types.

At step S102, the obtained at least one pre-defined named entity may be any specific entity or class/category of entity types. For example, a specific named entity may be the name of a specific individual, e.g. “John Smith”, while a class/category may be personal names. The named entity may be, for example, names of specific individuals (e.g. personnel or people associated with the environment, including client names), person names, organisation names, locations, financial information, passport number, driver license number, car registration number/license plate, social security number or national insurance number, employee ID, monetary values, and so on. It will be understood that named entities are not limited to proper nouns or names of individuals, locations or organisations. It will also be understood that the above is a non-exhaustive and non-limiting list of example named entities.

At step S100, selecting data items may comprise selecting data items that are most likely to improve training of the ML model. That is, it may be advantageous to populate the training dataset with data items that will improve the training of the ML model. Typically, data items that are diverse in content, format, style, and so on improve the training of a ML model. Similarly, data items which are more difficult to classify (i.e. more difficult to determine whether they contain a named entity) may be more useful to train the ML model.

A model that has been specifically trained to perform “smart sampling” may be used to perform the step (S100) of selecting data items. The model may be trained using the method described in US patent application number U.S. Ser. No. 18/921,328, which is herein incorporated by reference in its entirety. The model may be separate to the model that is being trained to perform named entity recognition in data items. Alternatively, both the smart sampling model and the model for performing named entity recognition (NER) may be part/subsets/sub-modules of a larger model or system. The smart sampling model may select a plurality of data items which are deemed, by the model, to be most useful for the training of the model being trained to performed NER. The most useful data items may be those which are difficult to categorise. The smart sampling model may have been specifically trained to identify whether a data item contains a named entity (a specific named entity /ntities (e.g. Joh Smith), or broader classes of named entities (e.g. person's name). In this way, when the smart sampling model is unsure about the presence of a named entity in a data item, that data item may be more useful for training the model being trained to perform NER.

The step S100 of selecting data items that are most likely to improve training of the ML model may comprise selecting data items for which the ML model will make predictions with a low certainty.

The method may further comprise: determining, using a large language model, LLM, whether each data item of the selected data items contains the at least one pre-defined named entity; wherein generating the training dataset (step S104) by labelling each data item may comprise using the determining to label each data item with the first label or second label. That is, the step of labelling the selected, unlabelled data items may comprise using an LLM to analyse the content of the data items and determining whether the named entity (or entities) are present within the data items. This advantageously harnesses the power of LLMs, but on a small set of data items, which is more efficient than analysing all the data items within the environment with an LLM. In other words, using an LLM is useful because an LLM is powerful and that power is used to form the training dataset. However, an LLM is too inefficient to use to analyse all the data items in an organisation. So, instead, it is used to generate the training dataset, and then another smaller, more efficient model (e.g. a classifier) is trained using that training dataset to identify data items with a high chance of containing the named entities.

The step of determining whether each data item contains the at least one pre-defined named entity may comprise: identifying text, using the LLM, in each data item which corresponds to the at least one pre-defined named entity.

Prior to the determining, the method may comprise: converting a non-text data item into text. This may be useful for data items that do not contain any text content which can be easily processed or analysed by the LLM. The converting may comprise generating text content for a non-text data item. The generated text content may be a description or summary of the non-text data item. For example, if the non-text data item is an image (e.g. photograph, frame of a video, medical image, graph, schematic diagram, flowchart, diagram, etc.), the generated text content may summarise the meaning and content of the image. In another example, if the non-text data item is an image that contains text (e.g. a photo of a passport or driver's license), then the text within that image may be extracted from the image to generate the text content. A large language model may be used to generate the text content, for example. This may be the same LLM which is used to label the data items.

The step S100 of selecting the subset of data items may be repeated until the training dataset contains a first pre-determined number of data items with the first label and a second pre-determined number of data items with the second label. The first pre-determined number may be the same as or different to the second pre-determined number. For example, it may be useful to have an equal number of positive samples (those which contain a named entity) and negative samples (those which do not contain a named entity), or it may be useful to have more of one type of sample than another.

Prior to the determining, the method may further comprise: dividing the selected data item into two or more segments, wherein the determining is performed for each segment of the two or more segments. That is, in cases where a data item is very large or contains a lot of text, the LLM may find it difficult to process the data item in one go. Thus, it is useful to divide the text content within the data item (or the text content generated for or extracted from a non-text data item) into chunks or segments. One reason for this is that the context window of many models is limited. For example, for OpenAI, the context window is 8k tokens (i.e. words), and for some open-source models, it can be as low as 512 tokens (words). So, it is necessary to reduce the amount of text that is fed into the model to identify whether any named entities are present. The text may be divided into pages, paragraphs, or into segments of a certain number of words. It will be understood that any suitable way of dividing the text may be used. Dividing the extracted text content into segments is also known as “chunking”.

Prior to the determining, the method may further comprise: translating text in the selected data item into a pre-defined natural language. A natural language is any language used by humans, as opposed to, for example, computer programming languages. The pre-defined natural language may be a human language that is selected or determined in advance, and may be linked to the language used to train the machine learning model and/or the language best understood by the LLM. Any suitable technique may be used to perform the translation. For example, the translation may be performed using machine translation techniques, which may utilise a large language model or other natural language processing mechanism.

Once the dataset has been generated, the next step of the method involves model training. An automated machine learning (AutoML) solution may be used to train the model. The training dataset comprises the data items as well as their labels, where the labels indicate whether the entity (or entities) of interest exists in the data items. The data items may be converted into embedding vectors, so that the data items can be used to train the mode. The model being trained may be any suitable classifier or classification model, such as, for example, XGBoost (eXtreme Gradient Boosting). It will be understood this is a non-limiting example model type. Hyperparameter tuning of the model may be erformed using AutoML. The output of the training process is a trained model. The trained model is capable of handling large context windows of up to 128K tokens. While the model could consider the frequency of appearance of a named entity in a data item, the main goal of the model is to act as a filter, so that only certain data items are processed further.

Step S106 of training the machine learning, ML, model using the generated training dataset to identify sensitive information may comprise training a classifier or classification model. Classifiers are a type of machine learning model that divide data into groups called classes. Classifiers learn class characteristics from training data and learn to assign possible classes to new data items using those learned characteristics.

At step S106, training the machine learning, ML, model using the generated training dataset may comprise, for each data item in the training dataset: determining, using the ML model, a label for the data item indicating whether the data item contains at least one pre-defined named entity; calculating a loss based on a difference between the determined label with the label of the data item; and training the ML model to minimise the calculated loss. Any suitable training technique may be used.

Once the model has been trained, it can be used to perform named entity recognition on all data items stored within the environment. The trained model predicts the likelihood of the presence of specific NER entities in each document. As explained below, the data items that receive high prediction scores from the trained model, indicating that the named entity (or entities) of interest likely exists within them, are sent for further processing by a more powerful model, e.g. an LLM. The LLM is able to identify the exact location of the named entities within these data items. This approach is more computationally-effective and cost-effective than processing all the data items using the LLM, as the LLM focuses on the most promising candidates.

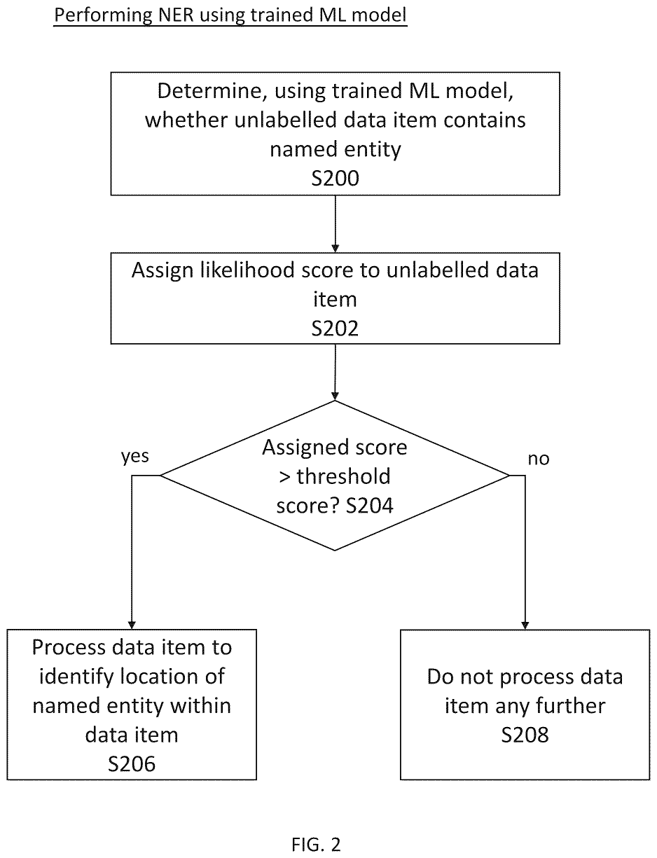

FIG. 2 is a flowchart of example steps for using a trained machine learning, ML, model to autonomously perform named entity recognition in data items within an environment. The method comprises: determining, using the trained ML model, for each unlabelled data item stored by at least one data storage device within the environment, whether the unlabelled data item contains at least one pre-defined named entity (step S200); assigning each unlabelled data item with a likelihood score indicating how confident the trained ML model is that the unlabelled data item contains the at least one pre-defined named entity (step S202); and processing each unlabelled data item with an assigned likelihood score above a pre-defined threshold likelihood score to identify a location of the at least one pre-defined named entity within the unlabelled data item (steps S204 and S206). Those data items with an assigned score equal to or less than the pre-defined threshold score are not processed any further (step S208).

At step S206, processing each unlabelled data item with an assigned likelihood score above a pre-defined threshold likelihood score may comprise using a large language model, LLM, to identify the location of the at least one pre-defined named entity within the unlabelled data item. This may be the same LLM which was used to generate the training dataset.

The method may further comprise: labelling each unlabelled data item having an assigned likelihood score above the pre-defined threshold likelihood score with at least one label corresponding to the at least one pre-defined named entity contained within the unlabelled data item. That is, an unlabelled data item may be labelled if the assigned score is above the threshold, so that the data item is now clearly marked as containing a specific named entity. The label may be specific to the named entity. For example, if a person's name is identified in the data item, the label applied to the data item may be “Name”. Similarly, if a specific town or city is identified in the data item, the label applied to the data item may be “Location”. Any suitable labelling technique may be used, depending on what is required for that particular environment or the security policies being deployed within that environment.

For each unlabelled data item having an assigned likelihood score above the pre-defined threshold likelihood score, the method may further comprise: outputting a snippet or summary of text in the unlabelled data item in which the at least one pre-defined named entity appears. This may be useful because it allows others, e.g. an administrator, to quickly see the context in which the named entity appears in the data item.

For each unlabelled data item having an assigned likelihood score above the pre-defined threshold likelihood score, the method may further comprise: extracting, redacting or deleting the at least one pre-defined named entity identified within the unlabelled data item.

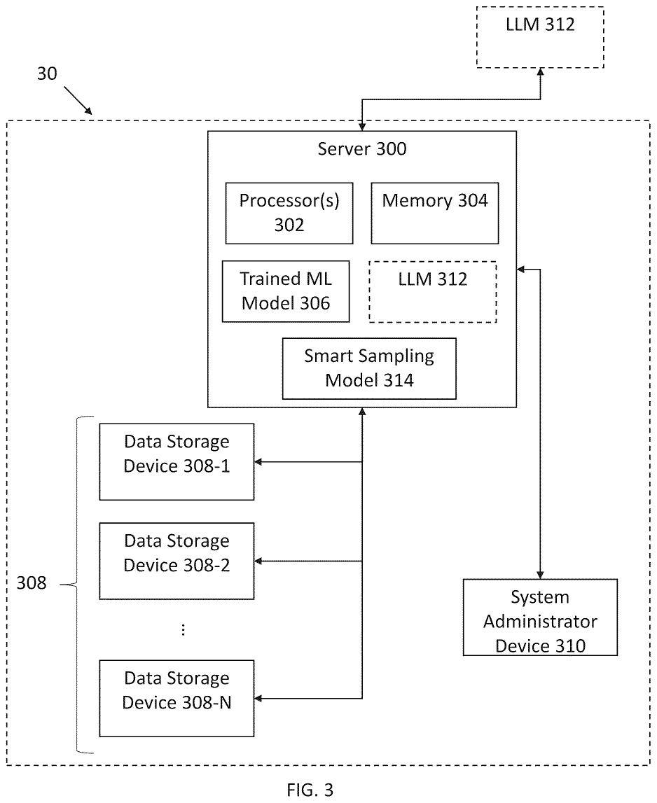

FIG. 3 is a block diagram of a system 30 for using a trained machine learning, ML, model to autonomously perform named entity recognition in data items within an environment.

The system 30 comprises: a plurality of data storage devices 308, each data storage device storing a plurality of labelled and unlabelled data items. It will be understood that there may be any number of data storage devices within the system and that three data storage devices 308-1, 308-2 and 308-N are shown in FIG. 3 for the sake of simplicity. Each data storage device 308 stores a plurality of data items.

The or each data storage device 308 may be any computing device within the environment. Examples of computing devices include laptops, desktop computers, smartphones, servers, and so on. More generally, the at least one data storage device may be any data storage within the environment, which includes file servers and any cloud-based data storage, such as those provided by Microsoft SharePoint, Google Drive, and so on.

The system 30 comprises a platform device or central server 300. The platform device or central server is communicatively coupled to the data storage devices 308 and is arranged to automatically classify the data items stored in the data storage devices. The platform device or central server 300 comprises at least one processor 302 coupled to memory 304.

The at least one processor 302 is arranged for: determining, using a trained ML model 306, for each unlabelled data item stored by the plurality of data storage device within the environment, whether the unlabelled data item contains at least one pre-defined named entity; assigning each unlabelled data item with a likelihood score indicating how confident the trained ML model is that the unlabelled data item contains the at least one pre-defined named entity; and processing each unlabelled data item with an assigned likelihood score above a pre-defined threshold likelihood score to identify a location of the at least one pre-defined named entity within the unlabelled data item.

The system 30 may further comprise a system administrator device 310, which may be operated by a human operator or may be automated. In some cases, the platform device or central server 300 may: transmit the snippets, summaries, and/or extracted entities for the data items processed by the LLM to the system administrator device 310, thereby enabling the system administrator device 310 to perform any necessary actions.

The system 30 may further comprise a large language model, LLM 312. In this case, processing each unlabelled data item with an assigned likelihood score above a pre-defined threshold likelihood score may comprise using the LLM, to identify the location of the at least one pre-defined named entity within the unlabelled data item. In some cases, the LLM 312 may be located within the system 30, e.g. within the server 300. In such cases, the step to identify the location of the named entity may be performed using the LLM 312 that is located within the system 30, to preserve data security and privacy. In other cases, the LLM 312 may be located external to system 30, as shown in FIG. 3. In such cases, the identifying may comprise sending the unlabelled data item to the LLM 312 that is located outside of the environment and system 30. This may be used if the data security policies permit data items to be transmitted with an LLM outside of the environment.

The system 30 may also comprise a smart sampling model 314, which may be used during the training of the model for NER (i.e. the model which becomes trained ML model 306 when the training has been completed). The smart sampling model 314 may be used to select data items from the data storage devices 308 to generate the training dataset used to train the model to perform NER.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for training a machine learning, ML, model to perform named entity recognition in data items within an environment, the method comprising:
selecting, from a plurality of unlabelled data items stored by at least one data storage device within the environment, a subset of data items;
obtaining at least one pre-defined named entity for the environment;
determining whether each data item of the selected data items contains the obtained at least one pre-defined named entity;
generating a training dataset comprising the selected subset of data items by labelling each data item in the selected subset by:
labelling the data item with a first label when the data item is determined to contain the at least one pre-defined named entity, or
labelling the data item with a second label when the data item is determined to not contain the at least one pre-defined named entity; and
training the ML model using the generated training dataset to perform named entity recognition.

2. The method of claim 1 wherein selecting a subset of data items comprises selecting any one or more of the following types of data item: an email, a document, a file, a text file, a folder, an image, a video, an audio file, a diagram, a geographical map, a medical image, a medical data file, a chat history, a transcript of an audio or video meeting, a prompt entered into an AI tool, and a portable document format file.

3. The method of claim 1 wherein selecting data items comprises selecting data items having a distribution that is most likely to improve training of the ML model.

4. The method of claim 3 wherein selecting data items comprises:
identifying data items, from the plurality of unlabelled data items, for which a prediction is made with a low confidence; and
selecting the identified data items as being most likely to improve training of the ML model.

5. The method of claim 4 wherein identifying data items comprises identifying data items for which a prediction is made with a confidence lower than a pre-defined confidence level.

6. The method of claim 3 wherein selecting data items comprises:
clustering the plurality of unlabelled data items into two or more clusters; and
selecting data items from the two or more clusters.

7. The method of claim 6 wherein selecting data items from the two or more clusters comprises selecting data items that are far apart from each other within each cluster.

8. The method of claim 1 further comprising:
determining, using a large language model, LLM, whether each data item of the selected data items contains the at least one pre-defined named entity;
wherein generating the training dataset by labelling each data item comprises using the determining to label each data item with the first label or second label.

9. The method of claim 8 wherein determining whether each data item contains the at least one pre-defined named entity comprises:
identifying text, using the LLM, in each data item which corresponds to the at least one pre-defined named entity.

10. The method of claim 9 wherein, prior to the identifying, the method comprises:
converting a non-text data item into text.

11. The method of claim 9 wherein, prior to the determining, the method further comprises:
translating text into a pre-defined natural language.

12. The method of claim 1 wherein, prior to training the ML model, the method comprises:
determining whether the training dataset comprises at least a first pre-determined number of data items with the first label and at least a second pre-determined number of data items with the second label.

13. The method of claim 12 wherein, when the training dataset contains less than the first pre-determined number of data items with the first label and the second pre-determined number of data items with the second label, the method comprises repeating the steps to select a subset of data items, determine whether the data items contain at least one pre-defined named entity, and generate a training dataset.

14. The method of claim 8 wherein, prior to determining whether each data item of the selected data items contains the at least one pre-defined named entity, the method further comprises:
dividing the selected data item into two or more segments having a size suitable for processing by the ML model,
wherein the determining is performed for each segment of the two or more segments.

15. The method of claim 1 wherein training the ML model comprises training a classifier model.

16. The method of claim 1 wherein training the ML model using the generated training dataset comprises, for each data item in the training dataset:
determining, using the ML model, a label for the data item indicating whether the data item contains at least one pre-defined named entity;
calculating a loss based on a difference between the determined label with the label of the data item applied during generation of the training dataset; and
training the ML model to minimise the calculated loss.

17. A computer-implemented method for using a trained machine learning, ML, model to autonomously perform named entity recognition in data items within an environment, the method comprising:
determining, using the trained ML model, for each unlabelled data item stored by at least one data storage device within the environment, whether the unlabelled data item contains at least one pre-defined named entity;
assigning each unlabelled data item with a likelihood score indicating how confident the trained ML model is that the unlabelled data item contains the at least one pre-defined named entity;
comparing each assigned likelihood score to a pre-defined threshold likelihood score; and
identifying, when the comparing determines that an assigned likelihood score is greater than or equal to a pre-defined threshold likelihood score, a location of the at least one pre-defined named entity within the unlabelled data item.

18. The method of claim 17 wherein the identifying comprises using a large language model, LLM, to identify the location of the at least one pre-defined named entity within the unlabelled data item.

19. The method of claim 17 further comprising:
labelling each unlabelled data item having an assigned likelihood score greater than or equal to the pre-defined threshold likelihood score with at least one label corresponding to the at least one pre-defined named entity contained within the unlabelled data item.

20. The method of claim 17, wherein for each unlabelled data item having an assigned likelihood score greater than or equal to the pre-defined threshold likelihood score, the method further comprises:
outputting a snippet or summary of text in the unlabelled data item in which the at least one pre-defined named entity appears; and/or
extracting the at least one pre-defined named entity identified within the unlabelled data item.

21. A system for using a trained machine learning, ML, model to autonomously perform named entity recognition in data items within an environment, the system comprising:
a plurality of data storage devices, each data storage device storing a plurality of labelled and unlabelled data items;
at least one processor coupled to memory, arranged for:
determining, using the trained ML model, for each unlabelled data item stored by the plurality of data storage device within the environment, whether the unlabelled data item contains at least one pre-defined named entity;
assigning each unlabelled data item with a likelihood score indicating how confident the trained ML model is that the unlabelled data item contains the at least one pre-defined named entity;
comparing each assigned likelihood score to a pre-defined threshold likelihood score; and
identifying, when the comparing determines that an assigned likelihood score is greater than or equal to a pre-defined threshold likelihood score, a location of the at least one pre-defined named entity within the unlabelled data item.
